(19) United States
(12) Patent Application Publication
(10) Pub. No.: US 2024/0147238 A1
(43) Pub. Date: May 2, 2024

(54) DIAMETER SPOOFING DETECTION AND POST-SPOOFING ATTACK PREVENTION

(71) Applicant: Telefonaktiebolaget LM Ericsson (publ), Stockholm (SE)

(72) Inventors: Hyame Alameddine, Montreal (CA); Taous Madi, Saint Laurent (CA); Amine Boukhtouta, Laval (CA); Daniel Migault, Montreal (CA)

(21) Appl. No.: 18/279,958

(22) PCT Filed: Mar. 2, 2021
(86) PCT No.: PCT/IB2021/051738

§ 371 Date: Sep. 1, 2023

(51) Int. Cl. H04W 12/122; H04L 9/40; H04W 12/63; H04W 84/04

(52) U.S. Cl. CPC H04W 12/122; H04L 63/1408; H04W 12/63; H04W 84/042

(57) ABSTRACT

The solutions and methods are directed to spoofing detection approaches and post-spoofing attack prevention schemes. When a first network node such as a Mobility Management Entity, MME, receives a request from an attacker, the first network node sends a modified copy of the request to a second network node such as Home Subscriber Server, HSS, for verification of the request. When the first network node receives a response from the second node and finds that the request is a spoofed request, the first network may disregard the request. This example of the spoofing detection approaches may help the second network node to avoid disruptions of services such as Denial-of-Service, DoS, attacks that could have been caused by multiple Update Location Requests, ULRs, sent by multiple User Equipment, UE, after the spoofing attempted by the attacker becomes successful.

### TECHNICAL FIELD

The present disclosure relates to solutions to security issues, in particular, spoofing attacks, exploiting the vulnerabilities in the Diameter protocol.

### BACKGROUND

### 1. Technical Background and Existing Technology

Telecommunication networks heavily rely on signaling protocols to control the communication between their network functions (e.g., Home Subscriber Server (HSS), Mobile Management Entity (MME), etc.). However, these signaling protocols have severe security vulnerabilities that may be exploited by attackers to attack mobile subscribers directly as well as the mobile operators' networks [1,2]. Signaling System 7 (SS7), Remote Authentication Dial-In User Service (RADIUS) and Diameter are examples of the signaling protocols. SS7 is a set of signaling protocols used to exchange information (e.g., call routing, roaming information, features available to subscribers, etc.) between the same and different networks in Second (2G) and Third (3G) Generation networks [1]. Fourth Generation (4G) networks, however, replaced RADIUS by the Diameter protocol [1]. The Diameter protocol will continue to be employed in Fifth Generation (5G) networks adopting a Non-Standalone (NSA) deployment that leverages 4G [3]. Hence, the following disclosure aims at addressing some security issues, mainly spoofing attacks, exploiting the vulnerabilities in the Diameter protocol.

1.1 Diameter protocol and network architecture

The Diameter base protocol is an Authentication, Authorization and Accounting (AAA) protocol that acts at the application layer of the Open Systems Interconnection (OSI) model and runs on top of the Transport Control Protocol (TCP)/Internet Protocol (IP) and Stream Control Transmission Protocol (SCTP) [4]. The Diameter base protocol is mainly used between a client and a server in order to grant or prevent access to a user [6]. The Diameter base protocol adopts a peer-to-peer architecture in which the client and the server are Diameter nodes. Diameter nodes implement the Diameter base protocol, which provides basic functionalities such as error notification, user sessions handling, and accounting. The Diameter base protocol may be extended to support other applications through Attribute Value Pairs (AVPs) that may be added to the Diameter message. AVPs may hold user authentication information, transportation of service specific authorization information, resource usage information, which may be used for accounting purposes, capacity planning, in addition to relaying, proxying and redirecting of Diameter messages through a server hierarchy [5]. The Diameter protocol is used for signaling between network functions within the same local operator's network or between roaming partners with either direct connection or indirect one through an Internetwork Packet Exchange (IPX) provider [2]. The Diameter protocol adopts a peer-to-peer architecture that leverages a set of Diameter agents such as Diameter Relay Agent (DRA), Diameter Proxy Agent (DPA), Diameter Translation Agent (DTA), and Diameter Redirect Agent which offer relay, routing and proxying functionalities in addition to translation between protocols (e.g., RADIUS and Diameter; Terminal Access Controller Access-Control System Plus (TACACS+) and Diameter; Mobile Application Part (MAP) and Diameter) respectively [4,5]. FIG. 1 represents a possible end-to-end architecture for the Diameter protocol in the case of roaming. This architecture accounts for the interconnection of Visited Public Mobile Network (VPMN) and Home Public Mobile Network (HPMN) through a General Packet Radio Services Roaming Exchange (GRX)/IPX provider. The IPX provider offers multiple functionalities to mobile operators such as Diameter firewalling and topology hiding, operational activities with roaming peers, Diameter messages inspection, international SMS delivery, SMS firewalling, and AVP addition, deletion and modifications among others [5].

1.2 Vulnerabilities of Diameter protocol

Securing Diameter-based communications between Diameter nodes by using Transport Layer Security (TLS) or Datagram Transport Layer Security (DTLS) is mandatory as specified by the standard [5,7]. IPsec may also be used to secure the Diameter-based communications [5,7]. Nonetheless, network operators overlook this security requirement which expands the attack surface of this protocol and makes it vulnerable to fraud, impersonation, Denial of Service (DoS), spoofing and location tracking attacks among others [1]. Multiple vulnerabilities and security threats exist in Diameter based networks and may be summarized as follows:

First, network operators occasionally use encryption in their network, mainly at the network boundaries. Encryption is only accounted for between peers, while end-to-end encryption remains absent in most cases. In fact, network operators rely on trust between each other and with IPX providers as there does not exist a way to monitor if encryption was used between hosts or if the information was intercepted or modified [7,10].

Second, the Diameter protocol relies on public key infrastructure and certificates for authentication which makes it vulnerable to all attacks related to key and certification management [5, 10].

Third, the Diameter protocol adopts a hop-by-hop routing strategy which

forces the Diameter response to follow the same route as the Diameter request [2,11]. This routing approach is a main vulnerability of the protocol as it allows an attacker to collect information and carry different types of attacks by spoofing a source of a request and receiving the response. This may result in a major disruption of the service and a DoS for the subscribers, which leads to severe revenue losses for the telecommunication operator.

Fourth, the Diameter protocol implements failover mechanisms to provide descriptive feedback in case of network or transport failure. The Diameter client initiates a failover procedure when it does not receive any answer for its request after a certain amount of time. An attacker may exploit failover mechanisms by flooding the peers with bogus traffic of the failover algorithms causing a DoS attack. Note that, even though the peer may detect that the failover traffic is faulty (in case filtering is applied by the peer), DoS attack may still be possible as the failover algorithm will attempt to process it in order to provide feedback [5,10].

The above vulnerabilities may be exploited by attackers to perform multiple attacks including spoofing attacks which we will tackle in this disclosure.

1.3 Spoofing attacks in Diameter-based networks

Multiple MNOs relied on mutual trust in their communications with no need for access control given their small number in previous years. They were indeed more concerned about their network resiliency and service availability rather than the security of their network [1]. With the development of telecommunications networks towards 5G and the increased number of MNOs, such approach is no longer efficient. The high level of openness and interconnections between a significant number of MNOs in 5G, the high number of Internet of Things (IoT) devices using the network, in addition to the employment of virtualization and softwarization increase the security risks in mobile networks. More precisely, security risks of signaling protocols such as the Diameter protocol are escalated given the increasing number of MNOs that are now interconnected with little security measures implemented in the interconnect network [1].

Those risks are aggravated by the vulnerabilities of this protocol which are related to its hop-by-hop routing. Hop-by-hop routing may be exploited to launch spoofing attacks, especially when the MNOs overlook securing Diameter signaling messages. The lack of encryption of Diameter messages prevents a valid authentication of the sender and makes the spoofing effective [1]. Spoofing attacks may be used by the attacker to cause a DoS on the network's subscribers. As an example, the attacker may spoof the MME and send a Purge User Equipment (UE) request to the HSS forcing the deletion of the MME attachment data stored in the HSS related to that UE, hence, preventing the latter from receiving messages or making calls. Spoofing may also cause a volumetric DoS on the deployed network functions, thus, putting the whole network infrastructure at risk [2]. For instance, a spoofed Reset Request (RSR) may result in large number of Update Location Requests (ULR) sent to the HSS and causing its DoS [2]. Hence, it is imperative to secure telecommunications networks against Diameter spoofing attacks by not only detecting the spoofing but also preventing its escalation to other types of attacks such as DoS attacks.

Spoofing in Diameter protocol may be achieved by impersonating a roaming partner through using the roaming partner's identity, usually specified in Origin-realm and Origin-host AVPs. The impersonating of a roaming partner consists of initiating a request with the Origin-realm AVP, Origin-host AVP, or a combination of the latter, set to a valid roaming partner or even the same network operator.

FIG. 2 illustrates one example of the RSR attack. An RSR is usually sent by an HSS as part of operation and maintenance actions to prevent service disruption during a planned HSS outage. The HSS uses the RSR to indicate to the MME the list of subscribers that will be affected by the outage, so that the MME will contact the HSS at the next authentication radio of these subscribers to update their locations using ULR.
Step 200: An attacker establishes a connection with a Diameter Edge Agent (DEA).
Step 202: The attacker sends an RSR to an MME.
Step 204: The MME marks a location information indicator of impacted International Mobile Subscriber Identities (IMSI) records as not confirmed.
Step 206: The MME sends a Reset Answer (RSA) message to the attacker.
Step 208: At the next authentication radio contact with one of UEs, the MME sends an update location request (ULR) to a legitimate HSS.

In other words, after retrieving the identity of the targeted MME (i.e., Destination-Host and Destination-Realm), the attacker poses as the HSS. The attacker sends an RSR with a range of IMSI. The MME will set the location confirmed of the subscribers with these identities as not confirmed and respond with reset answer. Due to the hop-by-hop vulnerability, the reset answer will follow the same path of the RSR and reach the attacker. At the next authentication radio of the subscribers whose IMSI's were specified in the RSR, the MME will send a ULR to the legitimate HSS to update their locations using ULR. Given the high number of ULRs, the HSS will suffer from a DoS. This DoS is a result of the spoofing attack.

In the following, a “spoofed operator” is an MNO who was impersonated by the attacker and whose identity was used to send a spoofed request (i.e., HSS in case of RSR attack) destinated to another node which we refer to by “attacked node” (i.e., MME in case of RSR attack).

Spoofing attacks may be detected by implementing simple Diameter filtering rules that disregard all messages in which the Origin-realm and the Origin-host AVPs do not belong to the same Mobile Network Operator (MNO) [2]. Diameter filtering rules were applied in in which the authors propose verifying if the binding relationship existing between the source domain, source host, and source IP address is correct in order to prevent Diameter signaling attacks originating from an HSS and targeting an MME or a Serving General Packet Radio Services Support Node (SGSN). If such binding relationship is incorrect, a Diameter response message with a failure code is returned to the HSS, stopping the processing of the request, and hence, preventing the signaling attack. Diameter filtering may be by-passed when the attacker impersonates an MNO by using valid identity information, which are the Origin-realm and the Origin-host AVPs belonging to the same MNO [2].

Spoofing detection and mitigation were addressed in [8]. The authors of [8] assume that the response to the spoofed request is returned to the spoofed MNO as they consider the SS7 protocol. In such a scenario, the spoofed operator may detect the attack by checking that the received response does not belong to a request sent by him. Hence, the authors of [8] suggest mirroring the response back to the attacked operator by changing the upper layer source address (e.g., realm) to the attacked operator and the destination set to that of the spoofed operator. This allows the attacked operator to detect the attack as the attacked operator will receive an abnormal response sent by itself. The authors of [8] suggest applying filtering rules and raising an alarm upon the receipt of such messages.

In addition, further investigation may be carried to detect the spoofed request (mainly track down the request and routing rules and then blacklist the message from the attacker's IP address or IMSI). Note that such detection and mitigation strategies cannot be applied in Diameter as the response will be sent back to the attacker.

### 2. Problems with existing solutions

Existing spoofing detection and prevention techniques are either general and do not target the specific case of Diameter spoofing attacks or may only detect one facet of the attack. In addition, existing solutions do not account for the specific hop-by-hop routing vulnerability in Diameter.

In fact, the authors of [7] have shown that Diameter filtering may be by-passed, and attacks may still be performed even when filtering is implemented as filtering rules do not cover all possible use cases (i.e., filtering cannot detect spoofing attack when origin-realm, origin-host and IP address are spoofed) [7]. An efficient filtering requires detailed administration; however, misconfiguration of filtering rules and network elements is always possible and may lead to severe legal and financial issues [1]. Thus, MNOs avoid applying filtering techniques as they may result in blocking legitimate messages originating from valid roaming subscribers which may cause severe revenue losses [7].

Further, in a roaming scenario, an MNO may not have direct control on filtering as he may have outsourced it to a third party such as an IPX. This puts a lot of responsibility on the IPX who needs to ensure service availability to its subscribers by carefully monitoring and filtering egress traffic [1].

General spoofing detection techniques such as those presented in [8] may be applied for SS7 spoofing attacks and hence, fail to consider the hop-by-hop routing vulnerability in the Diameter protocol. In fact, this technique assumes that the response to the spoofed request is returned to the spoofed operator rather than to the attacker in the case of Diameter. Further, the spoofing detection is done after the processing of the request by the attacked operator, which puts the reputation of the latter at serious risks and may cause revenue losses. For example, in the case of a spoofed Purge-UE request, the detection happens after the deletion of the MME attachment data of the UE in the HSS. Hence, the detection is done after allowing the spoofing to take effect and cause a DoS on the subscriber. This makes the spoofing successful. Hence, a detection and mitigation technique that do not only block spoofed requests but also restore the UE deleted data is required.

Considering the above shortcomings of existing solutions, there is a need for an efficient attack detection and prevention approach that: (a) accounts for the hop-by-hop routing vulnerability in Diameter protocol; (b) detects, blocks, and prevents the spoofing attack before the execution of the spoofed request; (c) prevents post-spoofing attacks such as DoS attacks; and (d) notifies the spoofed MNO of the attack and secure further communications with him.

### SUMMARY

Systems and methods are disclosed herein for spoofing detection and post-spoofing attack prevention. In one embodiment, a first network node performs a method of spoofing detection. The method comprises receiving a request in accordance with a protocol and establishing a new session with a second network node that is identified as a sender of the received request. The method further comprises sending a modified copy of the request to the second network node via the new session and receiving a response from the second network node, wherein the response indicates whether the request is a valid request. In this manner, a spoofing attack can be detected and prevented.

In one embodiment, the method further comprises determining that the request is not a valid request based on the response and disregarding the request responsive to determining that the request is not a valid request. In another embodiment, the method further comprises determining that the request is a valid request based on the response, executing the request, and sending a response to the second network node.

In one embodiment, in the modified copy of the request, the first network node is identified as a sender of the modified copy of the request, and the second network node is identified as a recipient of the modified copy of the request.

In one embodiment, the protocol is a Diameter protocol. In one embodiment, an origin-host and an origin-realm of the modified copy of the request are set to those of the first network node. In one embodiment, a destination-realm and a destination-host of the modified copy of the request are set to those of the second network node. In one embodiment, the received response is a Diameter Success message if the request is a valid request or a Diameter Limited Success message if the request is a spoofed request.

In one embodiment, the first network node is a Mobility Management Entity (MME), a Serving General Packet Radio Services Support Node (SGSN), or a Visited Location Register (VLR).

In one embodiment, the first network node is comprised in a first Public Land Mobile Network (PLMN), and the second network node is comprised in a second PLMN. In one embodiment, receiving the request comprises receiving the request via an edge node of the first PLMN that is communicatively coupled to an edge node of the second PLMN.

In another embodiment, the first network node and the second network are comprised in a PLMN.

In one embodiment, the method further comprises determining whether the request satisfies one or more criteria for validating the request, and the steps of establishing the new session with the second network node, sending the modified copy of the request to the second network node via the new session, and receiving the response from the second network node are performed responsive to determining that the request satisfies any of the one or more criteria. In one embodiment, the one or more criteria comprise: (a) a criterion that the request has a high risk of occurrence, (b) a criterion that the request is classified as having a high attack impact, (c) a criterion that the request is a first request exchanged on a respective session, or (d) a combination of any two or more of (a)-(c).

In one embodiment, a second network node performs a method of spoofing detection. The method comprises receiving a request from a first network node and determining that the request is a modified copy of a request that has been received by the first network node and for which the first network node is requesting validation that the request that has been received by the first network node was sent by the second network node. Responsive to determining that the request is a modified copy of the request that has been received by the first network node and for which the first network node is requesting validation, the method further comprises determining whether the request that has been received at the first network node is valid and sending a response to the first network node. The response indicates whether the request that has been received by the first network node is a valid request. In one embodiment, determining whether the request that has been received by the first network node is valid further comprises determining whether the request that has been received by the first network node was sent by the second network node.

In one embodiment, the request that has been received by the first network node is a request received by the first network node via a Diameter protocol. In one embodiment, an origin-host and an origin-realm of the modified copy of the request that has been received by the first network node are set to those of the first network node. In one embodiment, a destination-realm and a destination-host of the modified copy of the request that has been received by the first network node are set to those of the second network node. In one embodiment, the response sent to the first network node is a Diameter Success message if the request is a valid request or a Diameter Limited Success message if the request is a spoofed request.

In one embodiment, the request received from the first network node is a type of request that, for normal non-validation operation, is sent by the second network node but not received by the second network node. In one embodiment, the second network node is a Home Subscriber Server (HSS), a Home Location Register (HLR), a Mobility Management Entity (MME), or a Serving General Packet Radio Services Support Node (SGSN). In one embodiment, the edge node of the first PLMN is communicatively coupled to the edge node of the second PLMN via a General Packet Radio Services Roaming Exchange (GRX) provider and/or an Internet Packet Exchange (IPX) provider.

In one embodiment, a method performed by a first network node performing a testing of a spoofing detection comprises establishing a new session with a second network node, sending a test request to the second network node via the new session, and receiving a response from the second network node and saving the response in a log file.

Corresponding embodiments of a first network node are also disclosed. In one embodiment, a first network node is adapted to receive a request in accordance with a protocol and establish a new session with a second network node that is identified as a sender of the received request. The first network node is further adapted to send a modified copy of the request to the second network node via the new session and receive a response from the second network node. This indicates whether the request is a valid request.

In one embodiment, a first network node comprises processing circuitry that is configured to cause the first network node to receive a request in accordance with a protocol and establish a new session with a second network node identified as a sender of the received request. The processing circuitry is further configured to cause the first network node to send a modified copy of the request to the second network node via the new session and receive a response from the second network node, which indicates whether the request is a valid request.

Corresponding embodiments of a second network node are also disclosed. In one embodiment, a second network node is adapted to receive a request from a first network node and determine that the request is a modified copy of a request that has been received by the first network node and for which the first network node is requesting validation that the request that has been received by the first network node was sent by the second network node. Responsive to determining that the request is a modified copy of the request that has been received by the first network node and for which the first network node is requesting validation, the second network node is further adapted to determine whether the request that has been received at the first network node is valid and sends a response to the first network node, which indicates whether the request that has been received by the first network node is a valid request.

In one embodiment, a second network node comprises processing circuitry that is configured to cause the second network node to receive a request from a first network node and determine that the request is a modified copy of a request that has been received by the first network node and for which the first network node is requesting validation that the request that has been received by the first network node was sent by the second network node. Responsive to determining that the request is a modified copy of the request that has been received by the first network node and for which the first network node is requesting validation, the processing circuitry is further configured to cause the second network node to determine whether the request that has been received at the first network node is valid and sends a response to the first network node, which indicates whether the request that has been received by the first network node is a valid request.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of end-to-end architecture for Diameter roaming.

FIG. 2 illustrates one example of reset request attack.

FIG. 3 illustrates one example of peer-to-peer Diameter roaming architecture.

FIG. 4 illustrates one example of a spoofing attack scenario.

FIG. 5 illustrates one example of a spoofing attack detection approach.

FIG. 6 illustrates one example of RSR attack detection.

FIG. 7A illustrates a flow diagram between the first network node and the second network node.

FIG. 7B illustrates another flow diagram between the first network node and the second network node.

FIG. 8A illustrates a flow diagram of the spoofing detection approach.

FIG. 8B illustrates examples of security options shown in FIG. 8A.

FIG. 9 illustrates one example of a spoofing detection module deployed in a network node.

FIG. 10 illustrates one example of testing procedure performed by the first network node.

FIG. 11 is a schematic block diagram of a network node according to some embodiments of the present disclosure.

FIG. 12 is a schematic block diagram that illustrates a virtualized embodiment of the network node of FIG. 11 according to some embodiments of the present disclosure.

FIG. 13 is a schematic block diagram of the network node of FIG. 11 according to some other embodiments of the present disclosure.

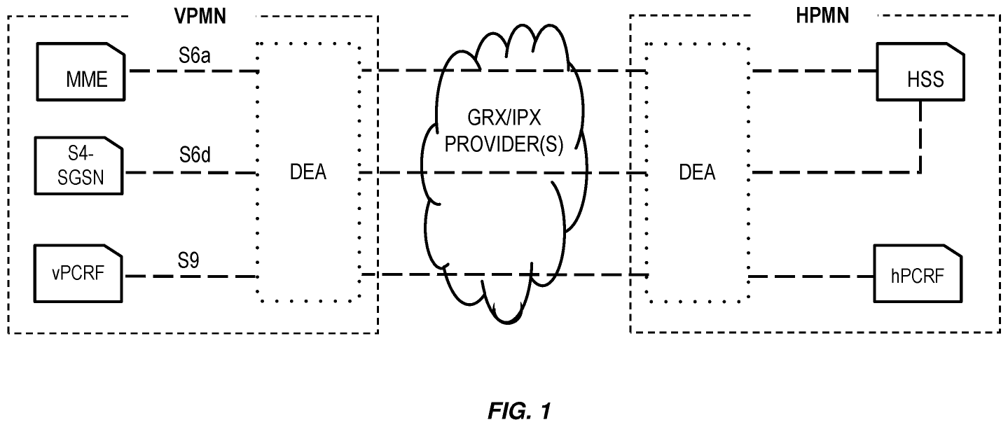

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or

a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a

wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Diameter protocol used for signaling in 4G/5G NSA networks is vulnerable to spoofing attacks. As a result of its hop-by-hop routing approach, an attacker may spoof the address of an MNO by launching Diameter requests and receiving the responses which may cause DoS attacks on the network subscribers as well as overload the MNO's network functions. In this disclosure, systems and methods for spoofing detection and post-spoofing prevention are disclosed. In some embodiments, the system and methods provide such solutions for the Diameter protocol; however, the present disclosure is not limited thereto. In one embodiment, an attacked node verifies the validity of the request before executing a received request and sending a response.

The systems and methods may provide one or more of the following advantages: (a) addresses the Diameter hop-by-hop routing security issue; (b) detects spoofing attacks in the network. While the present document tackles spoofing attacks with respect to Diameter protocol in 4G and NSA 5G networks, the same detection technique may be applied in any other network and peer-to-peer communication protocol such as SS7; (c) secures the network against spoofing attacks by blocking the spoofed requests; (d) prevents post-spoofing attacks by verifying the request validity (i.e., request was not spoofed); and (e) notifies the spoofed MNO of the attack.

Embodiments of the present disclosure may provide a number of advantages. For example, embodiments of the present disclosure may provide: (a) a novel spoofing detection strategy based on: (i) delaying the execution of the spoofed attack, (ii) sending a modified copy of the possibly spoofed request to the claimed sender in the initial request, (iii) receiving a response to the modified copy of the request sent, either confirming or denying that the initial request was sent by the claimed sender, and (iv) the modified copy of the request and its response shall be communicated through a new established session between the communicating parties; (b) a post-spoofing attack prevention approach through delaying then disabling the execution of the request if it was verified that it is a spoofed request; and (c) a notification to the spoofed node that it was impersonated specifying the request that was sent on its behalf.

### 3. Overview and Assumptions

Spoofing and impersonation attacks have been gaining significant attention. In fact, ThreatMetrix identified more than 11.4 million fraud attempts during peak holiday shopping [13]. Further, spoofing of wireless emergence presidential alerts was also shown possible in 4G LTE networks raising serious concerns [14]. This application discloses solutions and methods for spoofing attack detection and post-spoofing prevention in telecommunication networks (e.g., 2G, 3G, 4G, 5G, etc.) based on but not limited to Diameter protocol. The solutions and methods for detection approach in this application may be applied to any network and peer-to-peer protocol under the assumption that the attacker is not intercepting the messages between the spoofed node and the attacked one.

3.1 Network Architecture

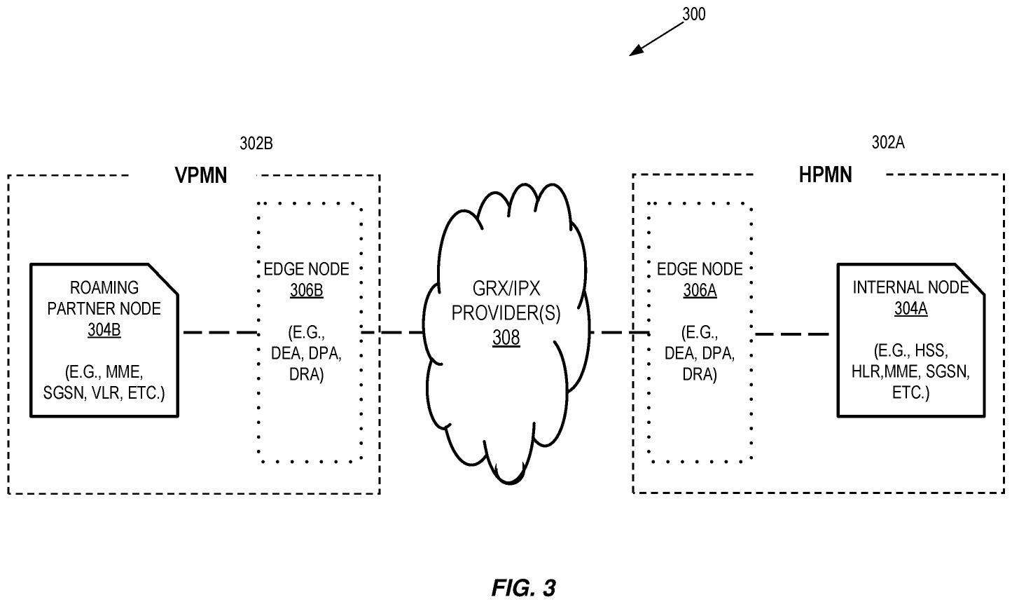

A peer-to-peer roaming architecture of the Diameter protocol is disclosed below. In this regard, FIG. 3 illustrates a system 300 having a peer-to-peer logical architecture at the Diameter level between two interconnecting MNO networks 302A and 302B. As illustrated, the MNO network 302A corresponds to an HPMN, and the MNO network 300B corresponds to a VPMN. Each MNO network 302A, 302B includes one or multiple network nodes (i.e., internal node 304A, roaming partner node 304B) which yield network functions that may be, but are not limited to, an MME, an HSS, a Serving General Packet Radio Services Support Node (SGSN), a Home Location Register (HLR), Visited Location Register (VLR), or the like. These network functions may communicate via a direct connection (which is not recommended practice from a security perspective) or through an edge node 306A, 306B that may be a Diameter Edge Agent (DEA), a Diameter Proxy Agent (DPA), or Diameter Relay Agent (DRA) [2]. The edge nodes 306A and 306B may communicate via a direct connection or through an interconnecting network 308 provided by one or more GRX/IPX providers [2].

The HPLMN 302A and the VPLMN 302B of FIG. 3 may be, e.g., 4G networks including E-UTRAN and EPC or may be NSA 5G networks including both eNBs and gNBs connected to EPC. While FIG. 3 illustrates an embodiment that the internal node 304A and the roaming partner node 304B are in separate two PLMNs 302A and 302B, they may alternatively be in the same PLMN. In other words, the internal node 304A and the roaming partner node 304B may be in the same HPMN 302A or in the same VPMN 302B.

3.2 Node specifications

The internal node 304A, the roaming partner node 304B, and the edge nodes 306A and 306B may be physical equipment or virtual nodes (e.g., virtual machines, containers). They include their own processing means such a Central Processing Unit (CPU) or virtual CPU (vCPU), storage and memory resources, and at least one program or application fulfilling a defined service. These resources are used to process a request and generate a response. The nodes 304A, 304B, 306A, 306B have at least one port and an interface allowing communication with other nodes.

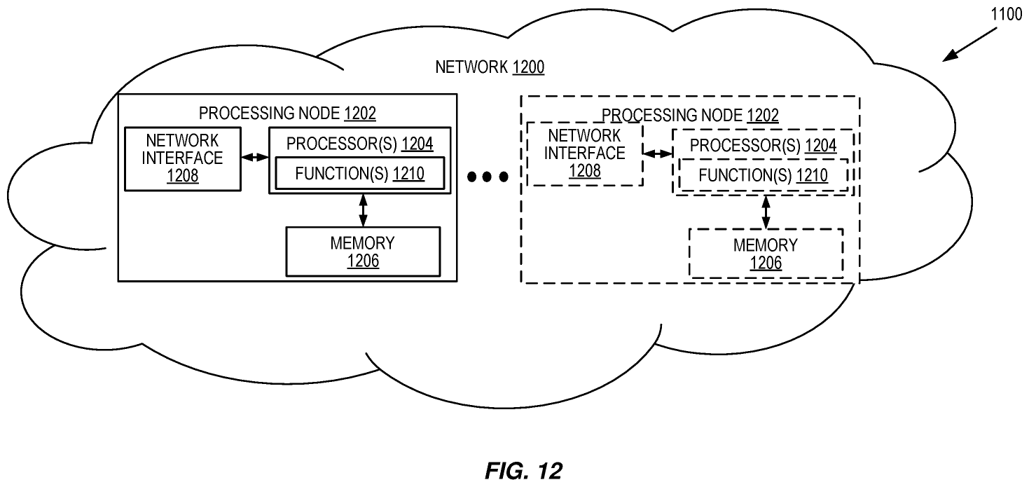

3.3 Attack Description and Assumptions A spoofing attack that may take place in a roaming scenario between two different MNOs (i.e., between the two MNO networks 1200 of FIG. 12), or in a non-roaming scenario, within the same MNO network is considered below. In both cases, the following assumptions are made with respect to the spoofing attack.

An attacker impersonates a node, that is, (a) the internal node 304A in the HPMN in case of roaming or (b) an internal node in an MNO's network in case of non-roaming scenario. For the remainder of this description, the internal node 304A is used for reference; however, it should be understood that, for the non-roaming case, the spoofed node may be another node in the same PLMN.

For the impersonation to take place, it is assumed that the attacker may spoof the identity of the internal node 304A (i.e., sender). The identity may be realm identity (i.e., origin-realm in case of Diameter protocol), host identity (i.e., origin-host in case of Diameter protocol) or a combination of the latter [2]. Those identities may be found via press releases on roaming agreements or roaming documents shared on the internet [8].

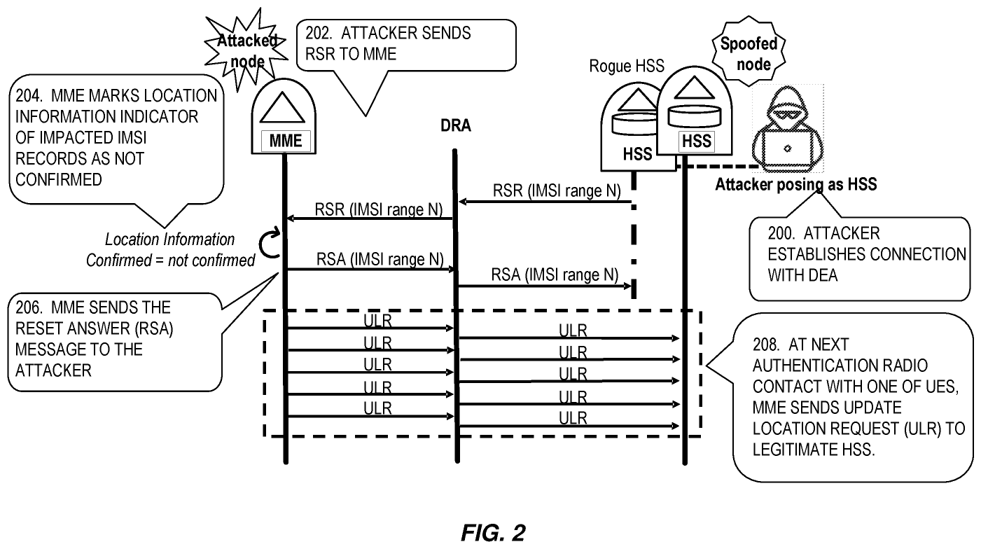

The attacker may establish a connection with the attacked node (i.e., the node receiving the attacker request), either through the edge node 306A (if any) of the HPMN or through the edge node 306B (if any) of the VPMN, or through direct connection with the attacked node (i.e., which may be in the VPMN in case of roaming or in the HPMN in non-roaming scenario). The attacker may be placed anywhere inside or outside the HPMN or VPMN networks. The attack may be launched through a comprised node that has access to the interconnect network (rogue node such as “rogue HSS” of FIG. 2) or it may be over the path interconnecting the spoofed node and the attacked one (i.e., man-in-the-middle attack).

The MNOs do not use reliable and secure communication (i.e., TLS, IPsec). Note that while the standard recommends the use of secure communication between MNOs, the latter does not comply with the standard and rely on trust between them [7,10].

The attacker knows the identity of the attacked node, that is, the targeted roaming partner node 304B that will process the request in case of roaming scenario or another targeted internal node in the MNO's network in case of non-roaming scenario. The identity of the attacked node is realm identity (i.e., Destination-realm in case of Diameter protocol), host identity (i.e., Destination-host in case of Diameter protocol) or a combination of both. Those identities may be found via press releases on roaming agreements or roaming documents shared on the internet [8]. Note that the Destination-realm AVP is mandatory while the Destination-host AVP is optional [9]. If the Destination-host is not present, it may be determined from the Application-Id field in the Diameter message [9].

The attacker may impersonate a node (i.e., the “impersonated node”) but not compromise it. The attacker is not intercepting the communication between the spoofed node and the attacked node. The attacker sends an attack request to the attacked node. The attack request is a message (e.g., Diameter message in the case where the Diameter protocol is used) that results in the addition, modification or deletion of one or multiple subscribers' data. Such type of requests includes but is not limited to ULR, Cancel Location Request, Insert Data Request, Purge-UE, Delete Subscriber Data Request and may result in a DoS against the subscriber. The attack request may also involve requests that launch other type of requests and may cause DoS against a network node (e.g., the spoofed node, etc.). Such type of requests includes but are not limited to RSR requests that may result in a high number of ULRs which may cause a DoS of the HSS (See FIG. 2).

For some attack requests such as those that may cause a DoS to the subscriber (i.e., ULR, etc.), it is assumed that the attacker knows the IMSI and the Mobile Station International Subscriber Directory Number (MSISDN) of the latter. Note that the IMSI may be obtained by sending a General Packet Radio Services (GPRS) Tunneling Protocol (GTP) Control (GTP-C) identification request message to the MME [15], or by attacking SS7 with a fake base station or by buying a database on the darknet [16].

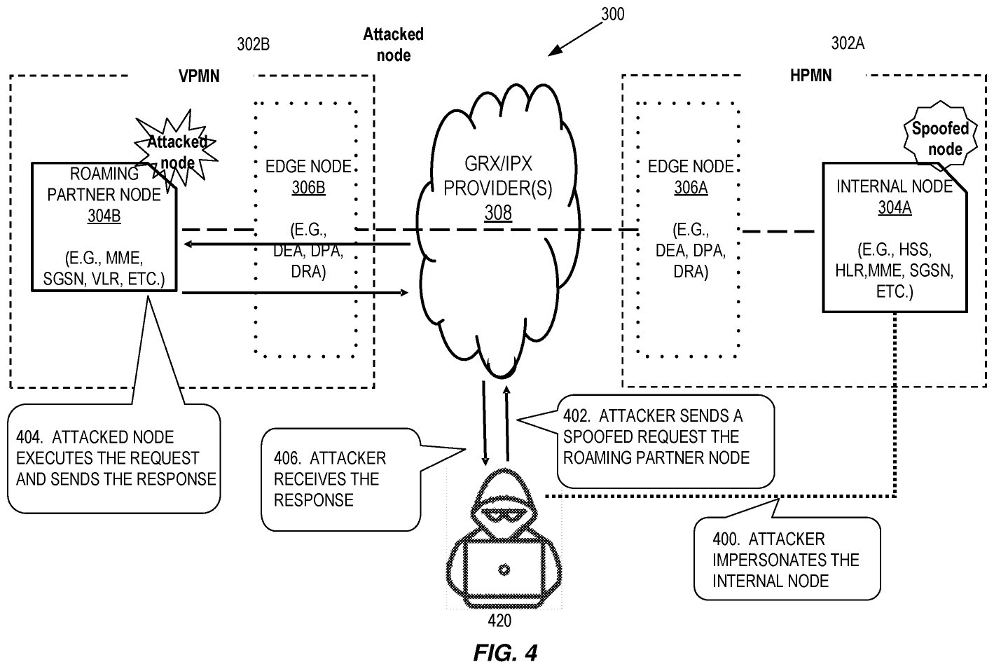

Considering the above assumptions, one example of attack scenario in the case of roaming is disclosed below and illustrated in FIG. 4. An attacker 420 gains access to the interconnected roaming network and establishes a connection with the attacked node, which in this example is the roaming partner node 304A (step 400). The attacked node refers to the node that will receive the spoofed request from the attacker 420.

The attacker 420 sends a Diameter request to the attacked node by setting the Destination-realm and/or the Destination-host to those of the latter (step 402). The Diameter request is spoofed and hence its sender identity (i.e., Origin realm, Origin-host) is set to the spoofed node, which in this example is the internal node 304A of the HPMN in FIG. 4.

The attacked node receives the spoofed request and executes the spoofed request (step 404). Note that based on the location of the attacker 420, the spoofed request may pass first by the Diameter edge node 306A of the HPMN and/or the interconnect network 308 (i.e., the GPX/IPX network), and/or the Diameter edge node 306B of the VPMN. Any of these elements may be implementing Diameter filtering rules to filter, for example, requests coming from invalid roaming partner (i.e., invalid Origin-realm) or those having an Origin-host not belonging to the mentioned Origin-realm, etc. However, these filtering rules will be by-passed by the spoofed request given that the node receiving the latter will have the impression that the message is sent by a legitimate roaming partner given the spoofed identity. In addition, as it is assumed that the operators do not use a reliable and secure authentication mechanism (i.e., IPsec, TLS), the identity of the sender cannot be verified. Therefore, the interconnection elements (i.e., edge nodes, IPX, etc.) will forward the message to the attacked node. After executing the request (e.g., updating subscriber's data in case of ULR for example), the attacked node responds with a Diameter answer corresponding to the received request to the attacker 420 (step 406). Given the hop-by-hop routing of the Diameter protocol, the Diameter answer will follow the same routing path of the spoofed request and hence, will be received by the attacker 420.

Note that during such attack, the attack node has the impression that it was communicating with a legitimate node from the HPMN, and the spoofed node in the HPMN has no idea that it was impersonated.

### 4. Spoofing Detection

As the execution of the spoofed request may cause a DoS to the subscriber or to a network node, it is of the best interest of the MNO receiving a Diameter request to verify its legitimacy before executing it, that is, to verify that the Diameter request is not a spoofed request. Hence, a spoofing detection approach that allows the victim MNO (i.e., attacked node in VPMN) to detect the spoofed request before executing it is disclosed. This prevents any DoS that may be caused by the attack, and hence protects the attacked MNO's network reputation and subscribers.

The spoofing detection approach comprises delaying the execution of the spoofed request to allow the attacked node to verify its validity first, that is, it is not a spoofed request. This may be done by double-checking with the claimed sender (i.e., Origin-realm, Origin-host of the request) that it is the actual sender of the request.

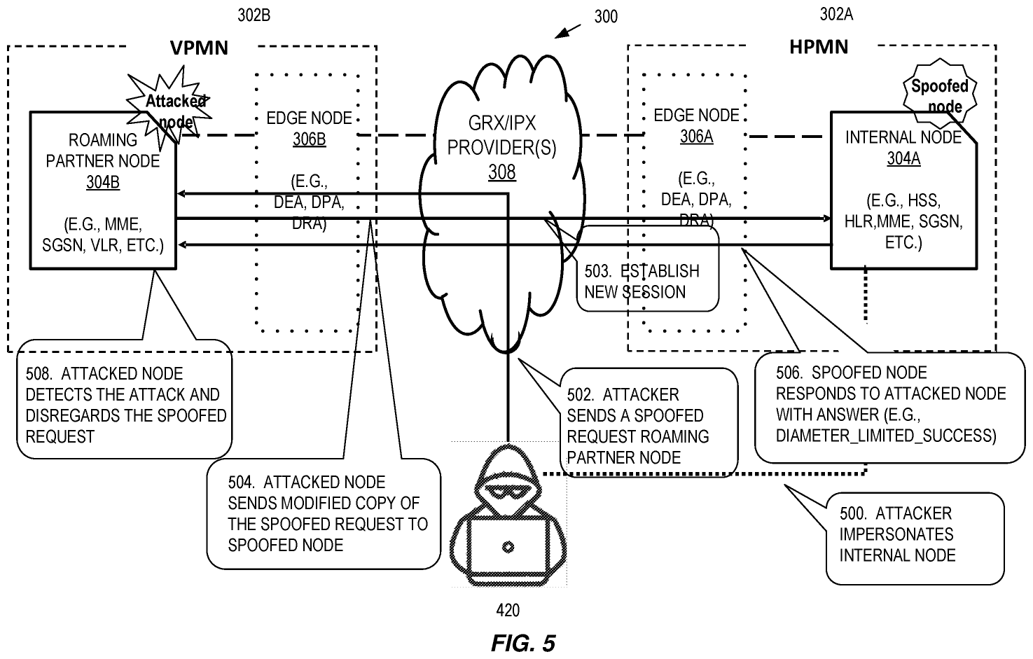

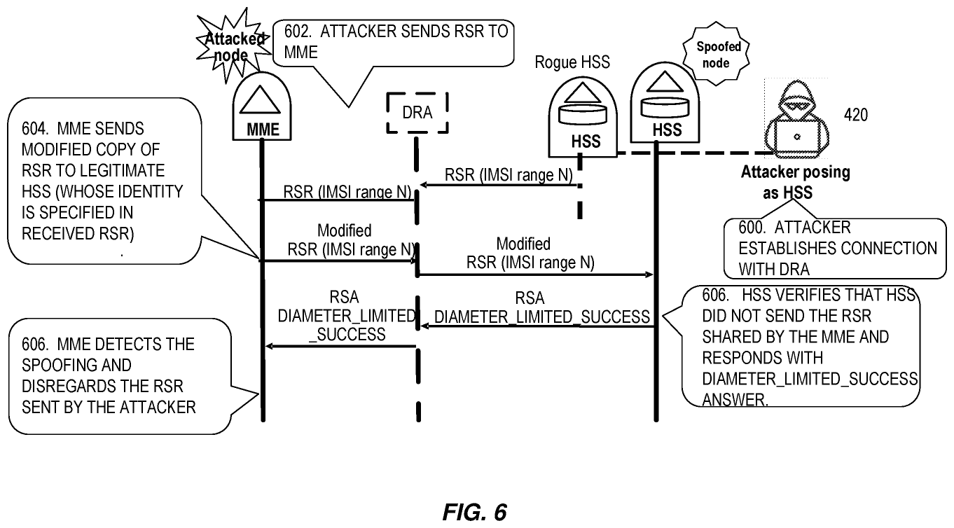

One embodiment of the spoofing detection approach is illustrated in FIG. 5 and may be performed as follows:
Step 500: An attacker 420 impersonates the internal node 304A.
Step 502: The attacker 420 sends a spoofed request to the roaming partner node 304B.
Step 503: Upon the receipt of a Diameter request, the roaming partner node 304B establishes a new session with the sender identified in the received request using the specified Origin-realm, Origin-host (i.e., identity of the internal node 304A in HPMN). Establishment of the new session is needed to prevent communication with the attacker 420 (if any). It is recommended that the new communication channel between the roaming partner node 304B in the VPMN and the internal node 304A in HPMN (i.e., spoofed node) follows the security recommendations of the Diameter protocol, that is, using TLS, DTLS or IPsec to secure the exchanged Diameter messages.
Step 504: After the session establishment between the attacked node (i.e., roaming partner node 304B in the VPMN) and the spoofed node (i.e., internal node 304A in the HPMN), the attacked node sends a copy of the request it received to the spoofed node after applying the following changes:
   Origin-host and Origin-realm are set to those of the attacked node since it is the sender.
   Destination-realm and Destination-host (optional) are set to that of the spoofed node.
The spoofed node will receive this new request from the attacked node. The spoofed node cannot process the new request because it is not part of its functionalities. Usually, the spoofed node sends such request but does not receive it. In this case, the spoofed node understands that the attacked node is trying to validate an earlier request that it received. Hence, the spoofed node will verify if it has sent a similar request to the attacked node. To better explain this, it is helpful to revisit the RSR attack presented in FIG. 2. Usually, RSRs are sent by HSS to the MME and processed by the MME. Then, the MME sends an RSA to the HSS. In one embodiment, a copy of the RSR is sent back to the HSS. The HSS will not be able to process it, and hence, will use it to verify if it has sent a similar request to the MME (See FIG. 6 that illustrates one example of RSR attack detection).
Step 506: If the request is verified (i.e., if the internal node 304A determines that it did in fact previously send the request to the roaming partner node 304B), the spoofed node will reply with a DIAMETER_SUCCESS in its Result-Code AVP in the Diameter answer. However, if the request was spoofed and was never sent by the spoofed node, then the latter will reply with DIAMETER_LIMITED_SUCCESS Result-Code AVP in the Diameter answer. DIAMETER_LIMITED_SUCCESS code is usually used to indicate that the request was successfully completed, but additional processing is required by the application. See [9]. Hence, using this result code (DIAMETER_LIMITED_SUCCESS) will convey to the attacked node that the processing of the request it sent to the spoofed node was successful, however, the spoofed node is confirming that it never sent a similar request before and that the request was spoofed. In case of the RSR attack detection in FIG. 6, the HSS will respond with an RSA with DIAMETER_LIMITED_SUCCESS to the MME, indicating that it never sent the shared RSR. Note that, usually the HSS does not send an RSA but receives it. Similarly, the MME usually sends an RSA but does not receive it. However, as the MME has already sent a copy of the RSR to the HSS, the MME will expect an RSA from the HSS.
Upon the receipt of a DIAMETER_SUCCESS, the attacked node will confirm that the request it received is valid, and hence, it will execute it and will send the response.
If the request was spoofed and the attacked node received a DIAMETER_LIMITED_SUCCESS, it will not execute the request the attacked node received and will disregard the request. The attacked node may also raise an alarm for further investigation and validation of the spoofed request and other similar received requests.

FIG. 6 illustrates the following steps of the spoofing detection approach that is applied to the RSR attack illustrated in FIG. 2:
Step 600: An attacker 420 establishes a connection with a DRA.
Step 602: The attacker 420 sends an RSR to an MME.
Step 604: The MME sends a modified copy of the RSR to a legitimate HSS (whose identity is specified in the received RSR).
Step 606: The HSS verifies that the HSS did not send the RSR shared by the MME. The HSS responds to the MME with an answer (e.g., DIAMETER_LIMITED_SUCCESS).

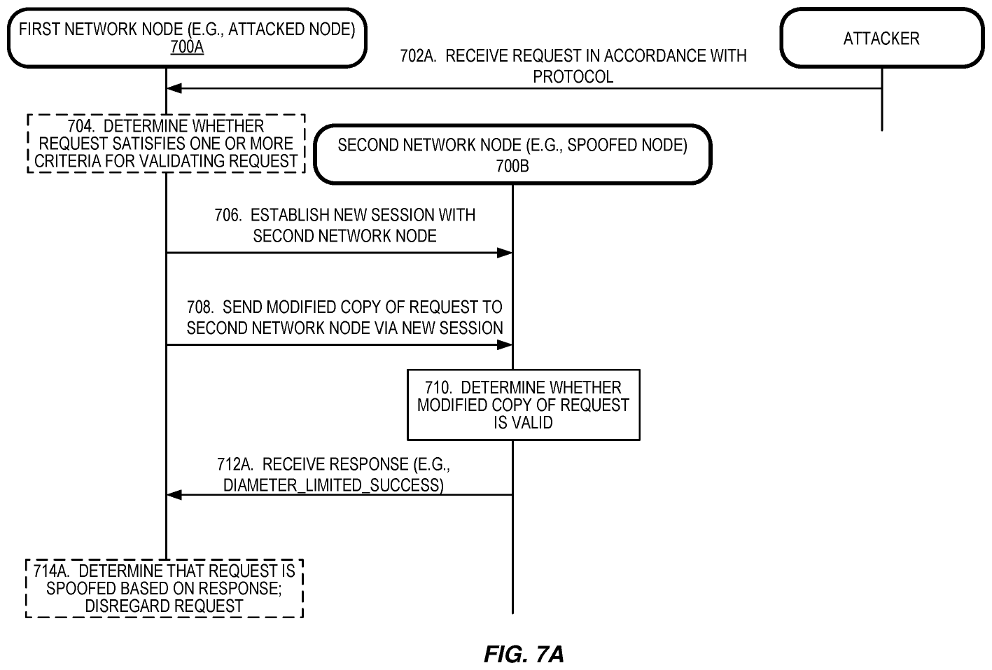

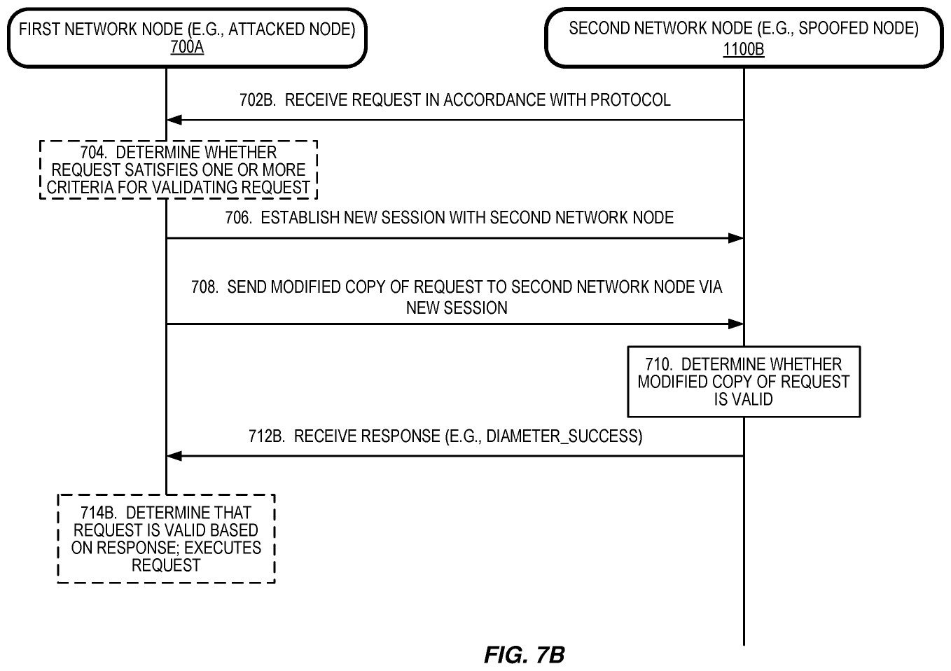

FIG. 7A illustrates the operation of a first network node 700A and a second network node 700B for spoofing detection in accordance with one embodiment of the present disclosure. In one example, the first network node 700A is the roaming partner node 304B in the VPLMN, and the second network node 700B is the internal node 304A in the HPLMN. In another example, the first and second network nodes 700A and 700B are both internal nodes in the same PLMN. In this example, there is a spoofing attack. The steps of the procedure of FIG. 7A are as follows:
Step 702A: The first network node 700A receives a request in accordance with a protocol (e.g., Diameter) from an attacker 420. The request identifies the second network node 700B as the sender of the request. For example, the request may be a Diameter request, as described above, and, as such, the details provided above regarding the Diameter request are equally applicable here. Note that, rather than executing the request, the first network node 700A performs the following steps to verify the request and will only execute the request if it is verified (or if the criteria for verifying the request in step 704 are not satisfied).
Step 704: Optionally, the first network node 700A determines whether the request satisfies one or more criteria for validating the request. Details regarding these one or more criteria are provided below. However, these criteria may be such that the request is verified only for certain types of requests or under certain conditions so as to limit the number of requests that are verified and thus limit the signaling and processing load on the system. If the one or more criteria are satisfied, the procedure proceeds to step 706. If not, the procedure ends and the first network node 700A executes the request.
Step 706: The first network node 700A establishes a new session with the second network node 700B.
Step 708: The first network node 700A sends a modified copy of the request to the second network node 700B via the new session. As described above, in the modified copy of the request, the first network node 700A is identified as the sender of the request, and optionally the second network node 700B is identified as the recipient of the request. Again, in one embodiment, the request is a Diameter request, where in the modified copy of the request,
   the Origin-host and Origin-realm is set to those of the first network node 700A since it is the sender, and
   optionally, the Destination-realm and Destination-host (optional) is set to that of the second network node 700B.
Step 710: The second network node 700B determines whether the request is valid based on the received modified copy of the request. In one embodiment, the second network node 700B determines that the received modified copy of the request is a request to verify the request and, as such, determines whether the second network node X900B sent that request to the first network node 700A. In this example, the second network node 700B determines that the request is not valid.
Step 712A: The second network node 700B sends, and the first network node 700A receives, a response (e.g., DIAMETER_LIMITED_SUCCESS) that indicates that the request is not valid.
Step 714A: Optionally, the first network node 700A determines that the request is spoofed based on the response, as such, disregards the request received in step 702A.

FIG. 7B illustrates another flow diagram between the first network node 700A and the second network node 700B that is similar to that of FIG. 7A but where the request is valid. The steps of the procedure of FIG. 7B are as follows:
Step 702B: The first network node 700A (e.g., the attacked node) receives a request in accordance with a protocol (e.g., Diameter) from the second network node 700B.
Step 704: Optionally, the first network node 700A determines whether the request satisfies one or more criteria for validating the request, as described above. If so, the procedure proceeds to step 706. If not, the procedure ends and the first network node 700A executes the request.
Step 706: The first network node 700A establishes a new session with the second network node 700B.
Step 708: The first network node 700A sends a modified copy of the request to the second network node 700B via the new session, as described above.
Step 710: The second network node 700B determines that the request is valid responsive to receiving the modified copy of the request, as described above.
Step 712B: The second network node 700B sends, and the first network node 700B receives, a response (e.g., DIAMETER_SUCCESS) that indicates that the request is valid.
Step 714B: Optionally, the first network node 700A determines that the request is valid based on the response and, as such, executes the request.

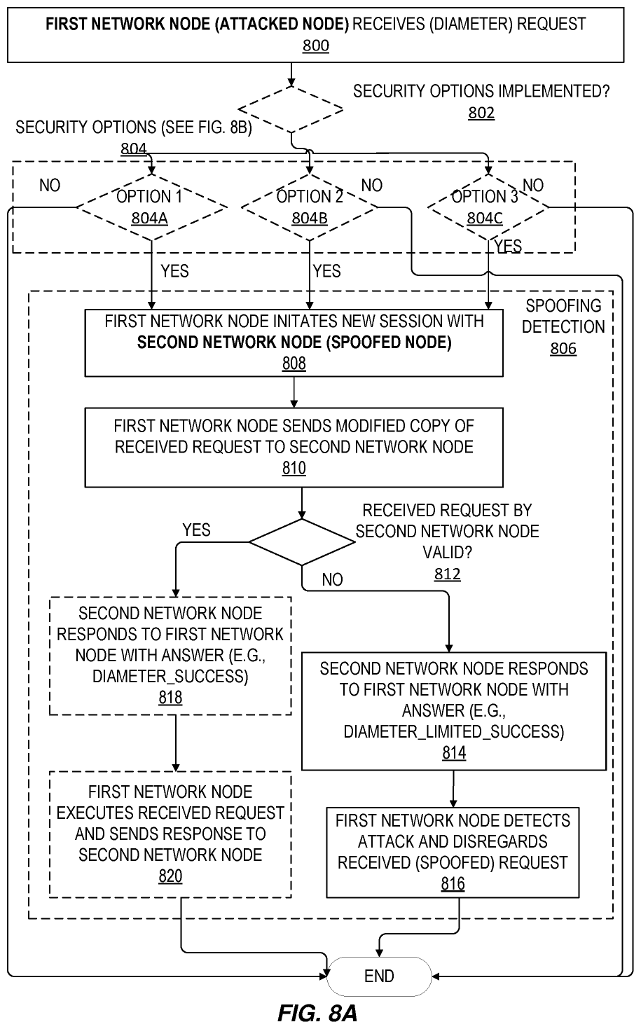

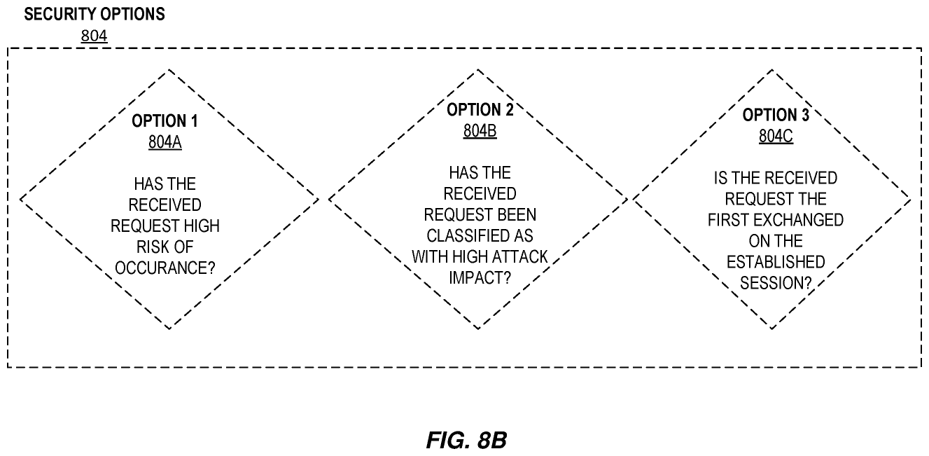

One example of spoofing detection approach, which is illustrated in FIG. 5 and FIGS. 7A and 7B, is illustrated in the flow diagram of FIG. 8A. Optional features are represented by dashed boxes. The steps of the procedure of FIG. 8A are as follows:
Step 800: The first network node 700A (e.g., the roaming partner node 304B) receives a request (e.g., a request in accordance with Diameter protocol), which may potentially be from an attacker. The request indicates the second network node 700B as the sender of the request.
Steps 802 and 804: Optionally, the first network node 700A determines whether one or more criteria for verifying the request are satisfied. The one or more criteria represent one or more security options. Multiple security options 804A, 804B, 804C are presented in FIGS. 7A and 7B. Any one or more of these security options may be considered for the application of the spoofing detection approach. Details regarding the multiple security options are provided below in the section entitled “Security options on the application of the spoofing detection solution.”
Step 808: The first network node 700A initiates or establishes a new session with the second network node 700B (e.g., the roaming partner node 304B) node.
Step 810: The first network node 700A sends a modified copy of the received request to the second network node 700B. For example, the request may be a Diameter request, and the modification of the request includes: (a) Origin-host and Origin-realm is set to those of the first network node 700A since it is the sender and optionally (b) Destination-realm and Destination-host is set to that of the second network node 700B.
Step 812: The second network node 700B determines whether the request is valid based on the received modified request.
Steps 814, 816: If the second network node 700B determines that the request is not valid, the second network node 700B responds to the first network node 700A with an answer (e.g., DIAMETER_LIMITED_SUCCESS) that indicates that the request is not valid. The first network node 700A then detects an attack from the attacker and disregards the received request.
Steps 818, 820: Alternatively, if the second network node 700B determines that the request is valid, the second network node 700B responds to the first network node 700A with an answer (e.g., DIAMETER_SUCCESS) that indicates that the request is valid. Optionally, the first network node 700A then executes the received request and sends a response to the second network node 700B.

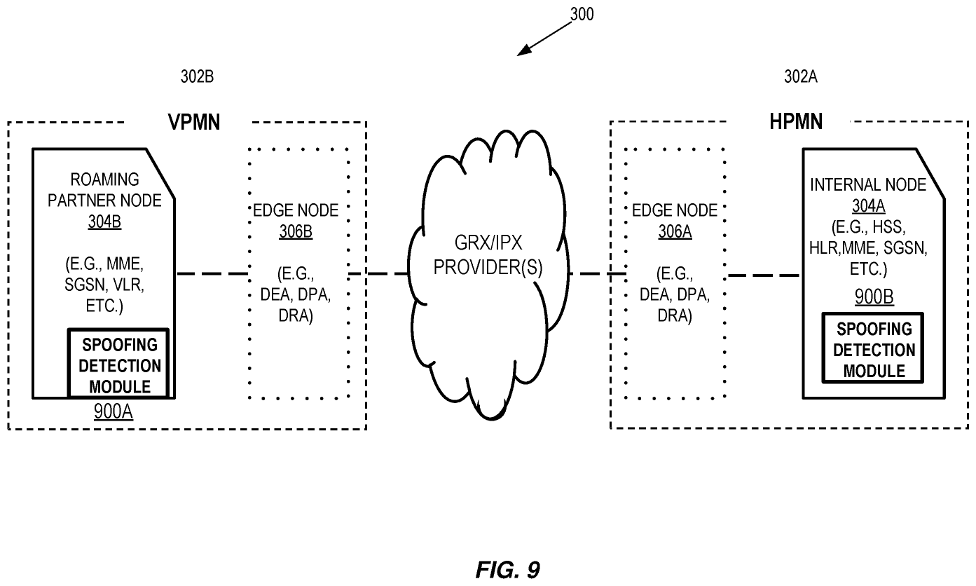

FIG. 9 illustrates that the spoofing detection approach may be implemented as an additional module (900A, 900B) in each Diameter node (e.g., roaming partner nodes 304B including MME, SGSN, VLR; internal nodes 304A including HSS, HLR, MME, SGSN) in an MNO's network using a software. The software (as an additional module of the Diameter nodes) may:
send a modified copy to the claimed sender of the received request to verify if the Diameter node was spoofed or not.
filter out requests that correspond to a valid Application-Id and Command-code on the mentioned interface and which were supposed to be sent by the node and not received by the node.
verify if the new received request is a modified copy of an earlier request sent by the Diameter node. This may be done by correlating the information contained in the AVPs of the received request such as IMSI, MSISDN among others.
trigger a Diameter response back to the sender of the modified copy of the request with the valid result code.
trigger the Diameter node to execute or disregard the initial request if it was identified as legitimate or spoofed, respectively.
raise an alarm in case spoofing was detected by communicating with other monitoring, filtering or attack detection tools. In this case, the spoofed request may be sent to the aforementioned tools for investigation.

### 5. Post-Spoofing Attack Prevention

The spoofing detection approach described herein suggests delaying the execution of the received request until its validity is verified. While this introduces additional delays in processing a legitimate request, it will save the network and the revenue of the MNO in case the request was spoofed. Hence, the spoofing detection approach prevents post-spoofing attacks that may be cascaded as a result of a spoofed request. In addition, the spoofing detection approach avoids the need for any mitigation solution to mitigate a spoofed request. By following the spoofing detection approach, only a valid request is processed. For example, by verifying the validity of an RSR request before executing the RSR request, we prevent the DoS on the subscribers as well as on the HSS (FIG. 2).

### 6. Security Options on the Application of the Proposed Spoofing Detection Solution

The solutions and methods of the present application provide an opportunity for communicating MNOs to collaborate in order to improve their security. In fact, not only the attacked node may detect that it was a victim of a spoofing attack but also the spoofed node is notified that it is being impersonated. This notification is depicted by the request the spoofed node received from the attacked one and which represents a modified copy of the spoofed request (FIG. 5). Further, the detection approach prevents any cascaded attacks that may result from the spoofing as it ensures the detection before the execution of the spoofed request by the attacked node. Hence, this detection and prevention solution brings many benefits to the targeted operators as it saves their reputation while preserving their revenues and their quality of service.

Despite these benefits, the proposed spoofing detection and post-spoofing prevention technique introduces additional signaling between the communicating nodes (i.e., attacked node and spoofed node), and hence, additional delays to the provided services, which might not be desired. Thus, there exists a tradeoff between the communication overhead introduced by the proposed solution and the security benefits it offers. For this reason, it is recommended that an MNO evaluates this tradeoff with respect to the risks hindering its network before applying the proposed solution.

Some security options are presented below about the applications of the proposed solution. The following security options may be incorporated into the procedure of FIG. 8A as further illustrated in FIG. 8B, as described above.

6.1 Option 1: Apply on requests with high risk of attack occurrence

FIG. 8B illustrates the multiple security options. Option 1 of the security options is that an MMO performs a risk assessment: “has the received request high risk of occurrence?” (step 804A).

As detailed in [2], most Diameter attacks are based on impersonating telecommunication network functions such as MME and HSS, among others. Attackers impersonate these network functions in order to perform multiple spoofing attacks with the aim of causing a DoS on the subscribers or the network, tracking the location of a subscriber, stealing the identity of the latter or even performing a charging fraud. The risk of occurrence of these attacks is highly dependent on the security measures deployed by the MNO, the skills of the attacker and its intentions. Thus, we recommend that an MNO performs a risk assessment on the likelihood of the occurrence of such attacks in its network along with the additional communication overhead that the proposed solution might incur in order to determine the list of requests to which it needs to be applied.

Nonetheless, some Diameter messages contain AVPs holding specific subscriber's or network information that are of high value for the attacker and may be used by the latter to perform other types of attacks. A risk assessment of AVPs was performed in [2], in which the following AVPs were identified as having a high risk:
Origin-Host and Origin-Realm are mainly prerequisites for the attacker to perform a spoofing attack and receive information in the answers. They are mainly present in most of Diameter messages [2].
User-Name, User-ID, respectively, hold an IMSI or an IMSI range and may be used to perform DoS attacks and user-related actions [2].
Visited-PLMN-ID may be used to manipulate the location information of a subscriber in the HSS [2].
Subscription-Data may be manipulated by the attacker to set wrong Access Point Network (APN) configuration information in the MME for the subscriber in order to perform DoS attack against the user or risk intercepting data due to resetting the APN [2].
Insert Data Request (IDR) and Delete Subscriber data Request (DSR) flags which may be employed for the retrieval of subscriber's location or for performing DoS attacks against users [2].
NOR flags may be used to perform DoS attacks against subscribers in order to cancel their location and/or remove their MME registration [2].

Thus, in one embodiment, the proposed detection and prevention solution is performed for the requests holding one or many of the above AVPs as they are likely to be manipulated by the attacker. As an option, the proposed solution may be implemented to the following requests:
ULRs that may be used to retrieve the MSISDN of a particular subscriber, to steal the identity of a user and to get access to the APN on behalf of the latter or even to manipulate the APN configuration and overwrite valid subscriber profile with compromised APN values [2].
NORs that may be used to manipulate APN information [17].
IDRs that may be employed to scan serving node in visiting network such as MME in order to find an IMSI, to fetch user location information, to impersonate a subscriber and even to modify charging characteristics and perform a charging fraud attack [2].
DSRs that may be used to find a particular IMSI by scanning serving nodes such as MME in a visiting network [2].

6.2 Option 2: Apply on requests with high attack impact

Option 2 of the security options is that an MMO performs another risk assessment: “has the received request been classified as with high attack impact?” (step 804B).

Along with the risk of the attack occurrence that is highly dependent on requests holding AVPs with high value for the attacker, the impact of the attack on the MNO, its network and its subscribers need to be also taken into consideration when deciding on the application of the proposed solution. In fact, the impact of some attacks is temporary and related to exactly one subscriber such as the DoS against a subscriber using ULR. Under such attack, the DoS of the subscriber is temporary, and the service may be restored whenever the user connects again to the network or updates its location [2]. However, other attacks may have a higher impact as they may cause a DoS against multiple subscribers as well as may cause another attack that results in a DoS on the network. RSR attack (FIG. 2) is an example of such attack. It starts by a DoS on the subscribers whose IMSI's are specified in the RSR and result in a DoS on the HSS given the high number of ULRs sent by the MME to the HSS. Thus, an MNO may opt for the option of applying the detection solution on Diameter requests that involve an update of multiple subscribers as well as those that may start other type of procedures such as RSRs.

6.3 Option 3: Apply only on the first request received during a session

Option 3 of the security options is that an MMO performs another risk assessment: “is the received request a first exchanged on the established session?” (step 804C).

In order to reduce the additional signaling overhead and delays that may be introduced by the spoofing detection approach when applied to each received request, we suggest applying it on the first request following a session establishment. More precisely, following a session establishment between two communicating nodes, one of the latter will send a request to the other. The receiver of the request will apply the solution in order to verify its validity, hence, to ensure that it is not spoofed. If the request was identified as valid, the communicating nodes may continue their communication using the same session without applying the solution for every subsequent request exchanged under that same session. This is a secure approach as we assume that the attacker is not intercepting nor eavesdropping their communication, nor compromised any of the communicating nodes. Hence, under those assumptions, all requests exchanged under the same session are valid if the first request exchanged under that same session is valid.

### 7. Testing Procedure

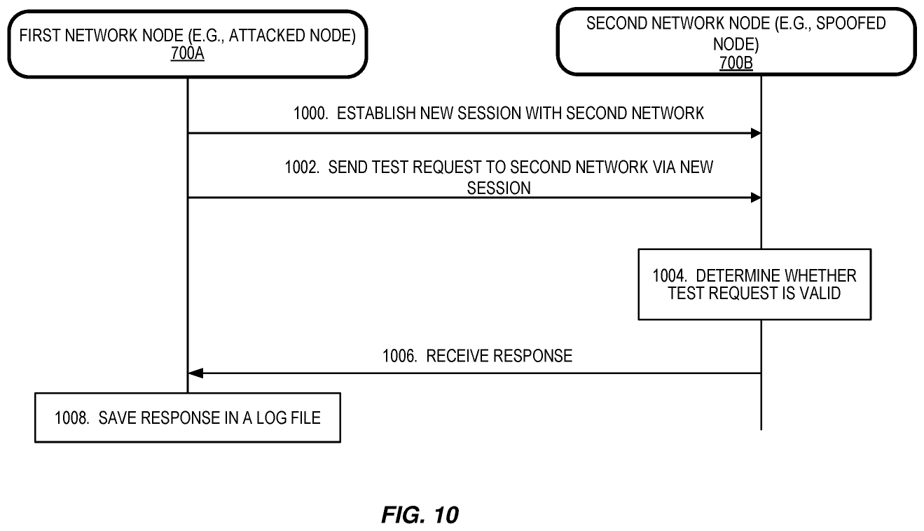

FIG. 10 illustrates one example of testing procedure performed by the first network node 700A. This testing procedure may, for example, be performed by the roaming partner node 304B to test whether the internal node 304A supports spoof detection as described herein. The steps of the procedure of FIG. 10 are as follows:
Step 1000: The first network node 700A establishes a new session with the second network node 700B.
Step 1002: The first network node 700A sends a test request to the second network node 700B via the new session. The test request is equivalent to a modified copy of a request that could have been received by the first network node 700A from an attacker.
Step 1004: Assuming that the second network node 700B supports spoof detection as described herein, the second network node 700B determines whether the request is valid.
Step 1006: The second network node 700B sends, and the first network node 700A receives, a response that indicates whether the request is valid. In the test case, the request will not be valid, and the response will indicate that the request is not valid.
Step 1008: The first network node 700A saves the response and/or information about the response in a log file.

### 8. Additional Description

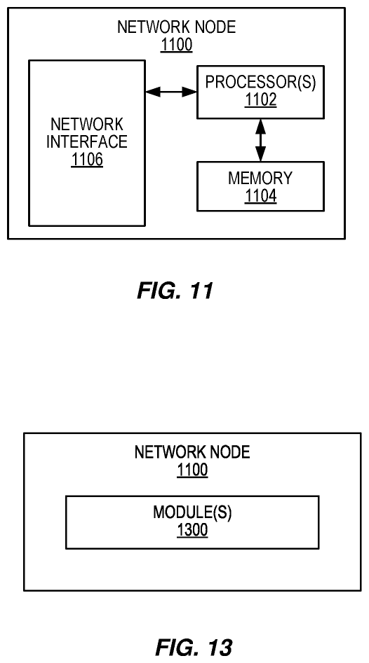

FIG. 11 is a schematic block diagram of a network node 1100 according to some embodiments of the present disclosure. Optional features are represented by dashed boxes. In particular, FIG. 11 depicts the technical requirements of a network node 1100, which in the Diameter specific embodiments described herein may also be referred to as a Diameter node. The network node 1100 may be, for example, the internal node 304A, the roaming partner node 304B, the edge node 306A, or the edge node 306B.

The network node 1100 may be, for example, a network node that implements all or part of the functionality of the attacked node, the spoofed node, the roaming partner node 304B, the internal node 304A, the first network node 700A, or the second network node 700B, as described herein. As illustrated, the network node 1100 includes one or more processors 1102 (e.g., Central Processing Units (CPUs), Application Specific Integrated Circuits (ASICs), Field Programmable Gate Arrays (FPGAs), and/or the like), memory 1104, and a network interface 1106. The one or more processors 1102 are also referred to herein as processing circuitry. The one or more processors 1102 operate to provide one or more functions of the network node 1100 as described herein (e.g., one or more functions of the attacked node, the spoofed node, the roaming partner node 304B, the internal node 304A, the first network node 700A, or the second network node 700B, as described herein). In some embodiments, the function(s) are implemented in software that is stored, e.g., in the memory 1104 and executed by the one or more processors 1102.

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the network node 1100 in which at least a portion of the functionality of the network node 1100 is implemented as a virtual component(s) (e.g., via a virtual machine(s) or a container(s) executing on a physical processing node(s) in a network(s)). As illustrated, in this example, the network node 1100 includes one or more processing nodes 1202 coupled to or included as part of a network(s) 1200. Each processing node 1202 includes one or more processors 1204 (e.g., CPUs, ASICs, FPGAs, and/or the like), memory 1206, and a network interface 1208.

In this example, functions 1210 of the network node 1100 described herein (e.g., one or more functions of the attacked node, the spoofed node, the roaming partner node 304B, the internal node 304A, the first network node 700A, or the second network node 700B, as described herein) are implemented at the one or more processing nodes 1202 or distributed across the two or more of the processing nodes 1202 in any desired manner. In some particular embodiments, some or all of the functions 1210 of the network node 1100 described herein are implemented as virtual components executed by one or more virtual machines or containers implemented in a virtual environment(s) hosted by the processing node(s) 1202.

In some embodiments, a computer program including instructions which, when executed by at least one processor, causes the at least one processor to carry out the functionality of the network node 1100 or a node (e.g., a processing node 1202) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The node 1100 includes one or more modules 1300, each of which is implemented in software. The module(s) 1300 provide(s) the functionality of the network node 1100 described herein. This discussion is equally applicable to the processing node 1202 of FIG. 12 where the modules 1300 may be implemented at one of the processing nodes 1202 or distributed across multiple processing nodes 1202.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in the memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Throughout the disclosure, the following references may be used:
[1] ENISA, “Signalling Security in Telecom SS7/Diameter/5G: EU level assessment of the current situation,” March 2018, available at https://www.enisa.europa.eu/publications/signallingsecurity-in-telecom-ss7-diameter-5g.
[2] GSMA, “Diameter Interconnect Security” v.8.0, January 2020, available at https://www.gsma.com/security/resources/fs-19-diameter-interconnect-security-v7-0/.
[3] GSMA, “5G Implementation Guidelines: NSA Option 3,” February 2020, available at www.gsma.com/futurenetworks/wiki/5g-implementation-guidelines/.
[4] EFFORT, “DIAMETER Architecture and Base Protocol,” 2014, available at http://www.efort.com/media_pdf/DIAMETER_EFORT_ENG.pdf.
[5] IETF, “Diameter base protocol,” September 2003, available at https://tools.ietf.org/html/rfc3588.
[6] Jeffrey L., Steven J., Hicks L., “Introduction to Diameter,” IBM, January 2006 available at https://www.ibm.com/developerworks/library/wi-diameter/wi-diameter-pdf.pdf.
[7] Positive Technologies, “Diameter vulnerabilities exposure report,” 2018 available at https://www.gsma.com/membership/resources/diameter-vulnerabilities-exposure-report-2018/.
[8] Martin K. Peylo and Silke Holtmanns, Nokia, “Diameter Edge Agent Attack Detection,” U.S. patent application Ser. No. 15/441,363.
[9] Diameter Message Processing (n.d.), available at https://diameter-protocol.blogspot.com/2012/07/diameter-message-processing.html.
[10] Bhanu Teja K., “Analysis and Experimental Verification of Diameter Attacks in Long Term Evolution Networks,” Aalto University, June 2016.
[11] Ericsson, “Ericsson Mobility Report, November 2020” (page 15, IoT Connections Outlook): Mobility Report.” Ericsson.com, 28 Apr. 2020, available at www.ericsson.com/en/mobility-report/reports/november-2019/iot-connections-outlook.
[12] Chengdong, H. E. “Method, Apparatus, and System for Preventing Diameter Signaling Attack in Wireless Network,” U.S. patent application Ser. No. 15/847,094.
[13] Zorz, M. “Data breaches lead to surge of spoofing attacks,” available at https://www.helpnetsecurity.com/2015/05/13/data-breaches-lead-to-surge-of-spoofing-attacks/.
[14] Lee, Gyuhong, et al. “This is your president speaking: spoofing alerts in 4G LTE networks.” Proceedings of the 17th Annual International Conference on Mobile Systems, Applications, and Services, 2019, available at http://lib.21h.io/library/Z8CE9L8M.
[15] Positive Technologies, “Threats to packet core security for 4G networks” available at https://positive-tech.com/research/epc-research/.
[16] Positive Technologies, “Threat vector: GTP Vulnerabilities in LTE and 5G networks 2020” available at https://positive-tech.com/knowledge-base/research/gtp-2020/.
[17] ETSI, “Universal Mobile Telecommunications System (UMTS); LTE; Evolved Packet System (EPS); Mobility Management Entity (MME) and Serving GPRS Support Node (SGSN) related interfaces based on Diameter protocol” (3GPP TS 29.272 version 16.5.0 Release 16).

At least some of the following abbreviations may be used in this disclosure. If there is any inconsistency between abbreviations, preference should be given to how it is used above. If listed multiple times below, the first listing should be preferred over any subsequent listing(s).
2G Second Generation
3G Third Generation
4G Fourth Generation
5G Fifth Generation
AAA Authentication, Authorization and Accounting
APN Access Point Network
AVP Attribute Value Pair
CPU Central Processing Unit
CTI Cyber Threat Intelligence
DEA Diameter Edge Agent
DoS Denial of Service
DPA Diameter Proxy Agent
DRA Diameter Relay Agent
DSR Delete Subscriber data Request
DTA Diameter Translation Agent
DTLS Datagram Transport layer Security
GRX General Packet Radio Services Roaming Exchange
hPCRF home Policy and Charging Rule Function
HLR Home Location Register
HPMN Home Public Mobile Network
HSS Home Subscriber Server
IDR Insert Data Request
IMSI International Mobile Subscriber Identity
IoT Internet of Things
IP Internet Protocol
IPSec Internet Protocol Security
IPX Internetwork Packet Exchange
MAP Mobile Application Part
MME Mobility Management Entity
MNO Mobile Network Operator
MSISDN International Subscriber Directory Number
NOR Notify Request
NSA Non-Standalone deployment
OSI Open Systems Interconnection
RADIUS Remote Authentication Dial-In User Service
RSR Reset Request
SCTP Stream Control Transmission Protocol
SGPRS Serving General Packet Radio Services
SGSN Serving General Packet Radio Services Support Node
SMS Short Message Service
SS7 Signaling System 7
TACACS+ Terminal Access Controller Access-Control System Plus
TCP/IP Transport Control Protocol/Internet Protocol
TLS Transport Layer Security
UE User Equipment
ULA Update Location Answer
ULR
vPCRF
vCPU
Update Location Requests
Visited Policy and Charging Rule Function
Virtual Central Processing Unit
VLR Visited Location Register
VPMN Visited Public Mobile Network

Those skilled in the art will recognize improvements and modifications to the embodiments of the present disclosure. All such improvements and modifications are considered within the scope of the concepts disclosed herein.

1. A method performed by a first network node performing a spoofing detection, the method comprising:
receiving a request in accordance with a protocol;
establishing a new session with a second network node, the second network node being identified as a sender of the received request;
sending a modified copy of the request to the second network node via the new session; and
receiving a response from the second network node, the response indicating whether the request is a valid request.

2. The method of claim 1 wherein the method further comprises:
determining that the request is not a valid request based on the response, and
disregarding the request responsive to determining that the request is not a valid request.

3. The method of claim 1 wherein the method further comprises:
determining that the request is a valid request based on the response, and
executing the request.

4. The method of claim 1 wherein, in the modified copy of the request, the first network node is identified as a sender of the modified copy of the request and the second network node is identified as a recipient of the modified copy of the request.

5. The method of claim 1 wherein the protocol is a Diameter protocol.

6. The method of claim 5 wherein an origin-host and an origin-realm of the modified copy of the request are set to those of the first network node.

7. The method of claim 5 wherein a destination-realm and a destination-host of the modified copy of the request are set to those of the second network node.

8. The method of claim 5 wherein the received response is a Diameter Success message if the request is a valid request or a Diameter Limited Success message if the request is a spoofed request.

9. The method of claim 1 wherein the first network node is a Mobility Management Entity, MME; a Serving General Packet Radio Services Support Node, SGSN; or a Visited Location Register, VLR.

10. The method of claim 1 wherein the second network node is a Home Subscriber Server, HSS; a Home Location Register, HLR; a Mobility Management Entity, MME; or a Serving General Packet Radio Services Support Node, SGSN.

11. The method of claim 1 wherein:
the first network node is comprised in a first Public Land Mobile Network, PLMN; and
the second network node is comprised in a second PLMN.

12. The method of claim 11 wherein:
receiving the request comprises receiving the request via an edge node of the first PLMN that is communicatively coupled to an edge node of the second PLMN.

13. The method of claim 12 wherein the edge node of the first PLMN is communicatively coupled to the edge node of the second PLMN via a General Packet Radio Services Roaming Exchange, GRX, provider and/or an Internet Packet Exchange, IPX, provider.

14. The method of claim 1 wherein the first network node and the second network node are comprised in a Public Land Mobile Network, PLMN.

15. The method of claim 1 further comprising:
determining whether the request satisfies one or more criteria for validating the request; and
wherein performing the steps of establishing the new session with the second network node, sending the modified copy of the request to the second network node via the new session, and receiving the response from the second network node are performed responsive to determining that the request satisfies any of the one or more criteria.

16. The method of claim 15 wherein the one or more criteria comprise at least one of the following:
(a) a criterion that the request has a high risk of occurrence;
(b) a criterion that the request is classified as having a high attack impact;
(c) a criterion that the request is a first request exchanged on a respective session; or
(d) a combination of any two or more of (a)-(c).

17. A method performed by a second network node performing a spoofing detection, the method comprising:
receiving a request from a first network node;
determining that the request is a modified copy of a request that has been received by the first network node and for which the first network node is requesting validation that the request that has been received by the first network node was sent by the second network node;
responsive to determining that the request is a modified copy of the request that has been received by the first network node and for which the first network node is requesting validation, determining whether the request that has been received at the first network node is valid; and
sending a response to the first network node, the response indicating whether the request that has been received by the first network node is a valid request.

18-29. (canceled)

30. A method performed by a first network node performing a testing of a spoofing detection, the method comprising:
establishing a new session with a second network node;
sending a test request to the second network node via the new session; and
receiving a response from the second network node and saving the response in a log file.

31. (canceled)

32. (canceled)

33. A first network node comprising processing circuitry configured to cause the first network node to:
receive a request in accordance with a protocol;
establish a new session with a second network node, the second network node being identified as a sender of the received request;
send a modified copy of the request to the second network node via the new session; and
receive a response from the second network node, the response indicating whether the request is a valid request.

34-36. (canceled)

37. A second network node comprising processing circuitry configured to cause the second network node to:
receive a request from a first network node;
determine that the request is a modified copy of a request that has been received by the first network node and for which the first network node is requesting validation that the request that has been received by the first network node was sent by the second network node;
responsive to determining that the request is a modified copy of the request that has been received by the first network node and for which the first network node is requesting validation, determine whether the request that has been received at the first network node is valid; and
send a response to the first network node, the response indicating whether the request that has been received by the first network node is a valid request.

38. (canceled)
